(19) United States
(12) Patent Application Publication
(10) Pub. No.: US 2022/0140672 A1
(43) Pub. Date: May 5, 2022

(54) ELECTRIC MOTOR, FAN, AND AIR CONDITIONER

(71) Applicant: Mitsubishi Electric Corporation, Tokyo (JP)

(72) Inventors: Takaya SHIMOKAWA, Tokyo (JP); Hiroki ASO, Tokyo (JP); Ryogo TAKAHASHI, Tokyo (JP); Naoki TAMURA, Tokyo (JP)

(21) Appl. No.: 17/434,061

(22) PCT Filed: Mar. 8, 2019
(86) PCT No.: PCT/JP2019/009320

§ 371 Date: Aug. 26, 2021

(51) Int. Cl. H02K 1/27; H02K 7/14; H02K 11/20; H02K 5/04; F04D 25/06

(52) U.S. Cl. CPC H02K 1/27; H02K 7/14; F24F 11/88; H02K 5/04; F04D 25/06; H02K 11/20

(57) ABSTRACT

An electric motor includes a rotor, a stator, and a magnetic sensor. The rotor includes a rotor core, a permanent magnet, and a sensor magnet. The magnetic sensor detects magnetic flux from the sensor magnet. The electric motor satisfies Rh1>Rm1, where Rh1 is a minimum distance from a rotation axis of the rotor to the magnetic sensor, and Rm1 is a minimum distance from the rotation axis to the permanent magnet.

### CROSS REFERENCE TO RELATED APPLICATION

This application is a U.S. National Stage Application of International Application No. PCT/JP2019/009320 filed on Mar. 8, 2019, the contents of which are incorporated herein by reference.

### TECHNICAL FIELD

The present invention relates to an electric motor.

### BACKGROUND

In general, an electric motor employs a magnetic sensor for detecting a rotation position of a rotor and a position detection magnet (also referred to as a sensor magnet) (see, for example, Patent Reference 1).

### PATENT REFERENCE

Patent Reference 1: Japanese Patent Application Publication No. 2003-52159

In the case of using the sensor magnet together with a consequent-pole type rotor, unbalanced leakage flux is generated from the consequent-pole type rotor between a north pole component and a south pole component. Accordingly, an error in detection result detected by a magnetic sensor increases in some cases. As a result, there is a problem in that accuracy in motor control decreases and motor efficiency decreases.

### SUMMARY

It is therefore an object of the present invention to prevent a decrease in motor efficiency of an electric motor including a consequent-pole type rotor.

An electric motor according to an aspect of the present invention includes: a consequent-pole type rotor having a rotation axis and including a rotor core, a permanent magnet fixed to the rotor core, and a sensor magnet fixed to the rotor core; a stator disposed outside the consequent-pole type rotor; and a magnetic sensor to detect magnetic flux from the sensor magnet, wherein the electric motor satisfies Rh1>Rm1 where Rh1 is a minimum distance from the rotation axis to the magnetic sensor, and Rm1 is a minimum distance from the rotation axis to the permanent magnet.

A fan according to another aspect of the present invention includes: a blade; and an electric motor to drive the blade, wherein the electric motor includes a consequent-pole type rotor having a rotation axis and including a rotor core, a permanent magnet fixed to the rotor core, and a sensor magnet fixed to the rotor core, a stator disposed outside the consequent-pole type rotor, and a magnetic sensor to detect magnetic flux from the sensor magnet, and the electric motor satisfies Rh1>Rm1 where Rh1 is a minimum distance from the rotation axis to the magnetic sensor, and Rm1 is a minimum distance from the rotation axis to the permanent magnet.

An air conditioner according to an aspect of the present invention includes: an indoor unit; and an outdoor unit connected to the indoor unit, wherein at least one of the indoor unit or the outdoor unit includes an electric motor, the electric motor includes a consequent-pole type rotor having a rotation axis and including a rotor core, a permanent magnet fixed to the rotor core, and a sensor magnet fixed to the rotor core, a stator disposed outside the consequent-pole type rotor, and a magnetic sensor to detect magnetic flux from the sensor magnet, and the electric motor satisfies Rh1>Rm1 where Rh1 is a minimum distance from the rotation axis to the magnetic sensor, and Rm1 is a minimum distance from the rotation axis to the permanent magnet.

According to the present invention, it is possible to prevent a decrease in motor efficiency of an electric motor including a consequent-pole type rotor.

### BRIEF DESCRIPTION OF THE DRAWINGS

FIG. 1 is a partial cross-sectional view schematically illustrating a structure of an electric motor according to a first embodiment of the present invention.

FIG. 2 is a cross-sectional view schematically illustrating a structure of a main magnet.

FIG. 3 is a diagram illustrating a positional relationship between a rotor and a magnetic sensor.

FIG. 4 is a diagram illustrating a positional relationship between the rotor and the magnetic sensor.

FIG. 5 is a graph showing a relationship between a minimum distance from an axis line to the magnetic sensor and a minimum distance from the main magnet to the magnetic sensor in an axial direction in a case where no detection error of the magnetic sensor is caused by the main magnet in the electric motor.

FIG. 6 is a graph showing a relationship between a detection error of the magnetic sensor in the electric motor and the minimum distance from the axis line to the magnetic sensor.

FIG. 7 is a graph showing a relationship between a detection value detected by the magnetic sensor in the electric motor and a position of the magnetic sensor.

FIG. 8 is a plan view schematically illustrating a structure of the sensor magnet.

FIG. 9 is a graph showing the magnitude of a magnetic flux density of magnetic flux showing a north pole of the sensor magnet (specifically, magnetic flux from the north pole toward the magnetic sensor).

FIG. 10 is a graph showing an example of change in a magnetic flux density of magnetic flux from the sensor magnet in the electric motor.

FIG. 11 is a graph showing examples of a change in a magnetic flux density of magnetic flux from the sensor magnetic flux density, a change in a magnetic flux density of magnetic flux from the main magnet, and a change in a magnetic flux density of magnetic flux flowing into the magnetic sensor in the electric motor.

FIG. 12 is a graph showing examples of a change in a magnetic flux density of magnetic flux from the sensor magnet, a change in a magnetic flux density of magnetic flux from the main magnet, and a change in a magnetic flux density of magnetic flux flowing into the magnetic sensor in the electric motor.

FIG. 13 is a diagram schematically illustrating a structure of a fan according to a second embodiment of the present invention.

FIG. 14 is a diagram schematically illustrating a configuration of an air conditioner according to a third embodiment of the present invention.

### DETAILED DESCRIPTION

### First Embodiment

An electric motor 1 according to a first embodiment of the present invention will be described.

In xyz orthogonal coordinate systems illustrated in the drawings, a z-axis direction (z axis) represents a direction parallel to an axis line Ax of the electric rotor 1, an x-axis direction (x axis) represents a direction orthogonal to the z-axis direction (z axis), and a y-axis direction (y axis) represents a direction orthogonal to both the z-axis direction and the x-axis direction. The axis line Ax is a rotation center of a rotor 2, that is, a rotation axis of the rotor 2. A direction parallel to the axis line Ax will be referred to as an “axial direction of the rotor 2” or simply as an “axial direction.” A radial direction refers to a direction of a radius of the rotor 2, and a direction orthogonal to the axis line Ax. An xy plane is a plane is a plane orthogonal to the axial direction.

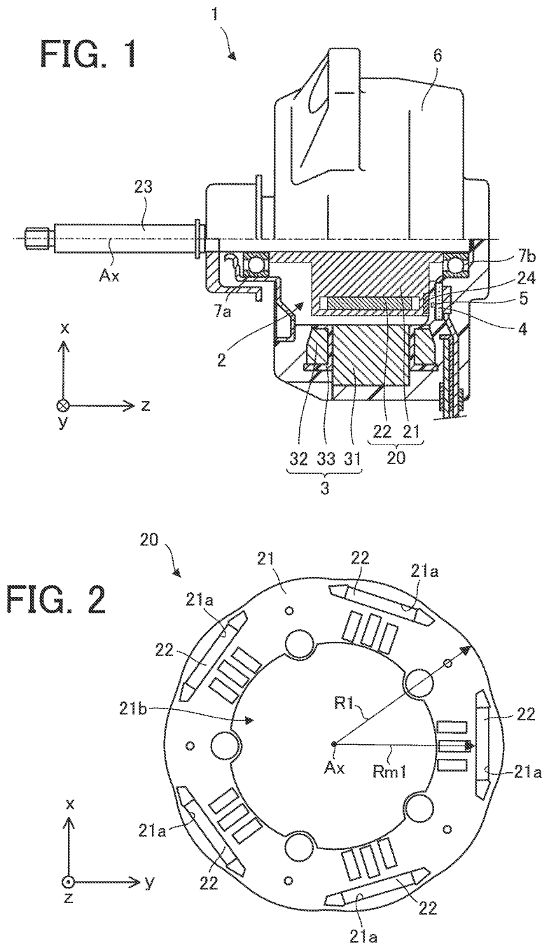

FIG. 1 is a partial cross-sectional view schematically illustrating a structure of the electric motor 1 according to the first embodiment.

The electric motor 1 includes the rotor 2, a stator 3, a circuit board 4, a magnetic sensor 5 configured to detect a rotation position of the rotor 2, and a molding resin 6. The electric motor 1 is, for example, a permanent magnet synchronous electric motor such as a permanent magnet-embedded electric motor (IPM electric motor).

The rotor 2 includes a main magnet 20, a shaft 23, and a sensor magnet 24. The rotor 2 is rotatably disposed inside the stator 3. The main magnet 20 includes a rotor core 21 and at least one permanent magnet 22. The rotation axis of the rotor 2 coincides with the axis line Ax. The rotor 2 is of a permanent magnet-embedded type, for example. In this embodiment, the rotor 2 is a consequent-pole type rotor.

The rotor core 21 is fixed to the shaft 23. The shaft 23 is rotatably held by bearings 7a and 7b. When the electric motor 1 is driven, the main magnet 20 and the sensor magnet 24 rotate together with the shaft 23.

In the axial direction, the rotor core 21 may be longer than a stator core 31. Accordingly, magnetic flux from the rotor 2 efficiently flows into the stator core 31.

Each permanent magnet 22 is fixed to the rotor core 21.

The sensor magnet 24 is fixed to the rotor core 21. Specifically, the sensor magnet 24 is fixed on one end side of the rotor 2 in the axial direction so as to face the magnetic sensor 5.

The sensor magnet 24 is a circular magnet. In this embodiment, the sensor magnet 24 is a ring-shaped magnet. It should be noted that the sensor magnet 24 may have a disc shape. The sensor magnet 24 is a magnet for detecting a rotation position of the rotor 2.

The sensor magnet 24 is magnetized in the axial direction to ease a flow of magnetic flux into the magnetic sensor 5. Accordingly, the magnetic sensor 5 can be attached to one end side of the stator 3 in the axial direction so as to face the sensor magnet 24. It should be noted that the direction of magnetic flux from the sensor magnet 24 is not limited to the axial direction.

The number of magnetic poles (e.g., the number of north poles) of the sensor magnet 24 is equal to the number of magnetic poles (e.g., the number of north poles) of the main magnet 20. The sensor magnet 24 is positioned such that polarity of the sensor magnet 24 coincides with polarity of the main magnet 20 in the circumferential direction. That is, in the circumferential direction, the positions of magnetic poles of the sensor magnet 24 coincide with the positions of magnetic poles of the main magnet 20.

The circuit board 4 is fixed to the stator 3. The magnetic sensor 5 is fixed to the circuit board 4, and faces the sensor magnet 24.

The rotor 2, specifically, the main magnet 20, has a first magnetic pole with a first polarity and a second magnetic pole with a second polarity different from the first polarity. In this embodiment, the first magnetic pole is a north pole, and the second magnetic pole is a south pole.

In the main magnet 20, a region including the permanent magnet 22 (which will be referred to as a first region) functions as one magnetic pole (e.g., a magnetic pole serving as a north pole to the stator 3), and a region between permanent magnets 22 adjacent to each other in the circumferential direction (which will be referred to as a second region) functions as another magnetic pole (e.g., a pseudo-magnetic pole serving as a south pole to the stator 3).

FIG. 2 is a cross-sectional view schematically illustrating a structure of the main magnet 20.

The rotor core 21 includes at least one magnet insertion hole 21a and a shaft hole 21b. In this embodiment, the rotor core 21 includes a plurality of magnet insertion holes 21a, and at least one permanent magnet 22 is disposed in each of the magnet insertion holes 21a. That is, in this embodiment, the electric motor 1 is an interior permanent magnet motor.

In this embodiment, the number of the permanent magnets 22 is half of the number n (where n is an even number greater than or equal to four) of magnetic poles of the rotor 2. The number n of magnetic poles of the rotor 2 is the sum of the number of magnetic poles functioning as north poles to the stator 3 and the number of magnetic poles functioning as south poles to the stator 3. The north poles and the south poles of the rotor 2 are alternately arranged in the circumferential direction of the rotor 2.

It should be noted that the electric motor 1 may be a surface magnet electric motor (SPM electric motor). In this case, the rotor core 21 includes no magnet insertion holes 21a, and permanent magnets 22 are attached to the outer peripheral surface of the rotor core 21.

The rotor core 21 is constituted by a plurality of electromagnetic steel sheets. The rotor core 21 may be an iron core having a predetermined shape. Each of the electromagnetic steel sheets has a thickness of 0.2 mm to 0.5 mm, for example. The electromagnetic steel sheets are stacked in the axial direction. It should be noted that the rotor core 21 may be a resin core formed by mixing a soft magnetic material and a resin, instead of the plurality of electromagnetic steel sheets.

The plurality of magnet insertion holes 21a are formed at regular intervals in the circumferential direction of the rotor core 21. In this embodiment, five magnet insertion holes 21a are formed in the rotor core 21. Each of the magnet insertion holes 21a penetrates the rotor core 21 in the axial direction.

The shaft hole 21b is formed in a center portion of the rotor core 21. The shaft hole 21b penetrates the rotor core 21 in the axial direction. The shaft 23 is disposed in the shaft hole 21b.

The shaft 23 is fixed to the rotor core 21 by a thermoplastic resin such as polybutylene terephthalate, press fitting, shrink fitting, or caulking. The shape of the thermoplastic resin is appropriately adjusted in accordance with purposes of the electric motor 1. In this case, the shaft hole 21b is filled with a thermoplastic resin that is a non-magnetic material.

The permanent magnet 22 is disposed in each of the magnet insertion holes 21a. Each permanent magnet 22 is, for example, a flat plate-shaped permanent magnet. In the magnet insertion hole 21a, a portion around the permanent magnet 22 is filled with a resin and consequently the permanent magnet 22 is fixed in the magnet insertion hole 21a. It should be noted that the permanent magnet 22 may be fixed by a method other than a fixing method using a resin. The permanent magnet 22 may be, for example, a rare earth magnet containing neodymium or samarium. The permanent magnet 22 may be a ferrite magnet containing iron. The type of the permanent magnet 22 is not limited to the example of this embodiment, and the permanent magnet 22 may be made of another material.

The permanent magnet 22 in each magnet insertion hole 21a is magnetized in the radial direction and consequently magnetic flux from the main magnet 20 flows into the stator 3. In this embodiment, each permanent magnet 22 forms a north pole of the main magnet 20 (specifically, a north pole functioning to the stator 3). In addition, each permanent magnet 22 (specifically, magnetic flux from the permanent magnet 22) forms a south pole that is a pseudo-magnetic pole of the main magnet 20 (specifically, a south pole functioning to the stator 3).

The stator 3 is disposed outside the rotor 2. The stator 3 includes the stator core 31, a coil 32, and an insulator 33. The stator core 31 is a ring-shaped core having a core back and a plurality of teeth.

The stator core 31 is made of, for example, a plurality of thin iron plates. In this embodiment, the stator core 31 is formed by stacking a plurality of electromagnetic steel sheets. Each of the electromagnetic steel sheets has a thickness of 0.2 mm to 0.5 mm, for example.

The coil 32 (i.e., winding) is wound around the insulator 33 attached to the stator core 31. The coil 32 is insulated by the insulator 33. The coil 32 is made of a material containing copper or aluminium, for example.

The insulator 33 is made of an insulative resin such as polybutylene terephthalate (PBT), polyphenylene sulfide (PPS), liquid crystal polymer (LCP), or polyethylene terephthalate (PET). The resin insulator 33 is a film having a thickness of 0.035 mm to 0.4 mm, for example.

For example, the insulator 33 is shaped integrally with the stator core 31. It should be noted that the insulator 33 may be shaped separately from the stator core 31. In this case, after the insulator 33 has been shaped, the insulator 33 is fitted in the stator core 31.

In this embodiment, the stator core 31, the coil 32, and the insulator 33 are covered with the molding resin 6. The stator core 31, the coil 32, and the insulator 33 may be fixed by a cylindrical shell made of a material containing iron, for example. In this case, the stator 3 is covered with a cylindrical shell by shrink fitting together with the rotor 2, for example.

The magnetic sensor 5 detects a rotation position of the rotor 2 by detecting a rotation position of the sensor magnet 24. The magnetic sensor 5 is, for example, an element such as a Hall IC, a magnetic resistance element (also referred to as an MR element), a giant magnetic resistance element (also referred to as a GMR element), or a magnetic impedance element. The magnetic sensor 5 is fixed at a detection position that is a position through which magnetic flux generated from the sensor magnet 24 passes.

A control circuit mounted on the circuit board 4 controls a current flowing in the coil 32 of the stator 3 by using a detection result obtained by the magnetic sensor 5 (e.g., a magnetic pole change point that is a boundary between a north pole and a south pole of the sensor magnet 24), thereby controlling the rotation of the rotor 2. The magnetic pole change point of the sensor magnet 24 is an inter-pole part of the sensor magnet 24.

The magnetic sensor 5 detects positions of magnetic poles (also referred to as phases) of the sensor magnet 24 and the main magnet 20 based on a change of a magnetic field flowing into the magnetic sensor 5, for example, a change in a magnetic flux density or a magnetic field strength. That is, the magnetic sensor 5 detects magnetic flux from the sensor magnet 24 to detect a rotation position of the rotor 2. More specifically, the magnetic sensor 5 detects magnetic flux from the north pole of the sensor magnet 24 and magnetic flux toward the south pole of the sensor magnet 24, thereby determining a timing when the direction of a magnetic field changes in the circumferential direction (also referred to as a rotation direction) of the sensor magnet 24, specifically, a magnetic pole change point of the sensor magnet 24. In the sensor magnet 24, the north poles and the south poles are alternately arranged in the circumferential direction. Thus, the magnetic sensor 5 periodically detects a magnetic pole change point of the sensor magnet 24, thereby enabling the detection of a position (specifically, a rotation angle and a phase of the rotor 2) of each magnetic pole in the rotation direction.

The molding resin 6 unites the magnetic sensor 5 and the circuit board 4 with the stator 3. The molding resin 6 is, for example, a thermosetting molding resin such as an unsaturated polyester resin (BMC) or an epoxy resin.

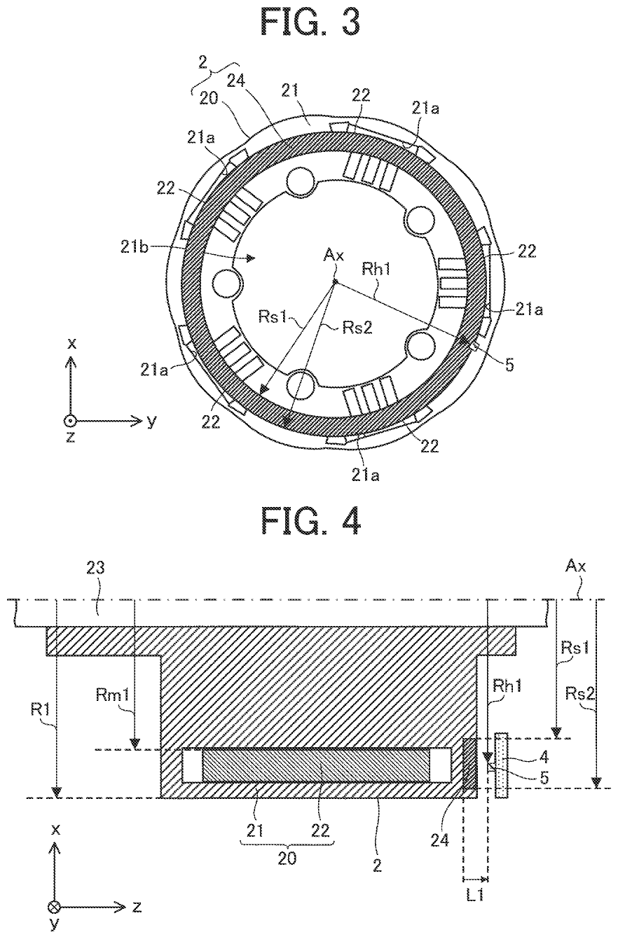

FIGS. 3 and 4 are diagrams each showing a positional relationship between the rotor 2 and the magnetic sensor 5.

Supposing a minimum distance from the axis line Ax (i.e., the rotation axis of the rotor 2) to the magnetic sensor 5 is Rh1 and a minimum distance from the axis line Ax to the permanent magnet 22 is Rm1, a relationship between the minimum distance Rh1 and the minimum distance Rm1 satisfies Rh1>Rm1. That is, the minimum distance Rh1 from the axis line Ax to the magnetic sensor 5 is longer than the minimum distance Rm1 from the axis line Ax to the permanent magnet 22.

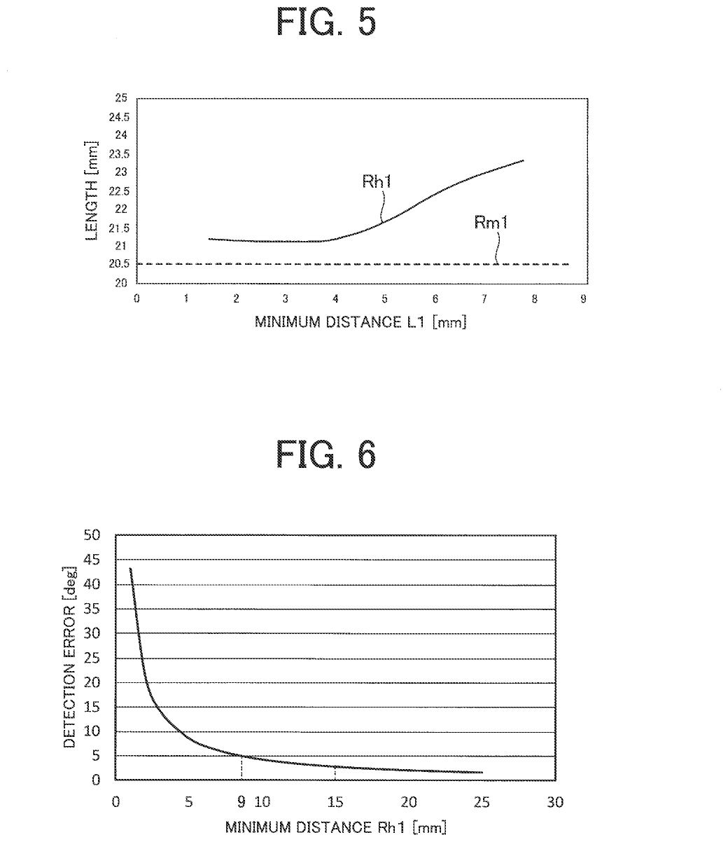

FIG. 5 is a graph showing a relationship between the minimum distance Rh1 from the axis line Ax to the magnetic sensor 5 and a minimum distance L1 from the main magnet 20 to the magnetic sensor 5 in the axial direction in a case where no detection error of the magnetic sensor 5 is caused by the main magnet 20 in the electric motor 1.

In the example shown in FIG. 5, the relationship between the minimum distance Rh1 to the magnetic sensor 5 and the minimum distance Rm1 from the axis line Ax to the permanent magnet 22 satisfies Rh1>Rm1. In the example shown in FIG. 5, the minimum distance Rm1 is 20.5 mm. In this case, if the minimum distance Rh1 is 21 mm or more, the magnetic sensor 5 can be attached to the electric motor 1 in such a manner that no detection error of the magnetic sensor 5 is caused by the main magnet 20 in the electric motor 1 independently of the minimum distance L1. Accordingly, even in a case where the minimum distance L1 from the main magnet 20 to the magnetic sensor 5 in the axial direction varies, an error in a detection result detected by the magnetic sensor 5 can be reduced. As a result, a decrease in motor efficiency can be prevented.

In addition, as shown in FIG. 4, supposing a maximum radius of the rotor core 21 is R1, a relationship between the maximum radius R1 and the minimum distance Rh1 from the axis line Ax to the magnetic sensor 5 satisfies R1>Rh1. That is, the maximum radius R1 of the rotor core 21 is larger than the minimum distance Rh1 from the axis line Ax to the magnetic sensor 5. In other words, the magnetic sensor 5 is located at a position where R1>Rh1 is satisfied. In this case, in the xy plane, the magnetic sensor 5 is located inside the outer peripheral surface of the rotor 2 (specifically, the rotor core 21). Accordingly, influence of a magnetic field generated from the coil 32 on the magnetic sensor 5 is reduced, and an error in a detection result detected by the magnetic sensor 5 can be reduced. As a result, a decrease in motor efficiency can be prevented.

FIG. 6 is a graph showing a relationship between a detection error of the magnetic sensor 5 in the electric motor 1 and the minimum distance Rh1 from the axis line Ax to the magnetic sensor 5. In FIG. 6, the vertical axis represents a detection error of the magnetic sensor 5, that is, a detection error [deg (electrical angle)] of a rotation position of the rotor 2 in the electric motor, and the horizontal axis represents the minimum distance Rh1 [mm] from the axis line Ax to the magnetic sensor 5.

As shown in FIG. 6, if the minimum distance Rh1 is smaller than 5 mm, the detection error of the magnetic sensor 5 increases. Thus, the minimum distance Rh1 is preferably 5 mm or more. Accordingly, even in a case where a placement position of the magnetic sensor 5 is shifted from a predetermined position, an error in a detection result detected by the magnetic sensor 5 can be reduced and consequently a decrease in motor efficiency can be reduced. As a result, a decrease in motor efficiency can be prevented.

The minimum distance Rh1 from the axis line Ax to the magnetic sensor 5 is more preferably 9 mm or more. In this case, the error in the detection result detected by the magnetic sensor 5 can be further reduced. As a result, a decrease in motor efficiency can be prevented.

The minimum distance Rh1 from the axis line Ax to the magnetic sensor 5 is much more preferably 15 mm or more. In this case, the error in the detection result detected by the magnetic sensor 5 can be further reduced. As a result, a decrease in motor efficiency can be prevented.

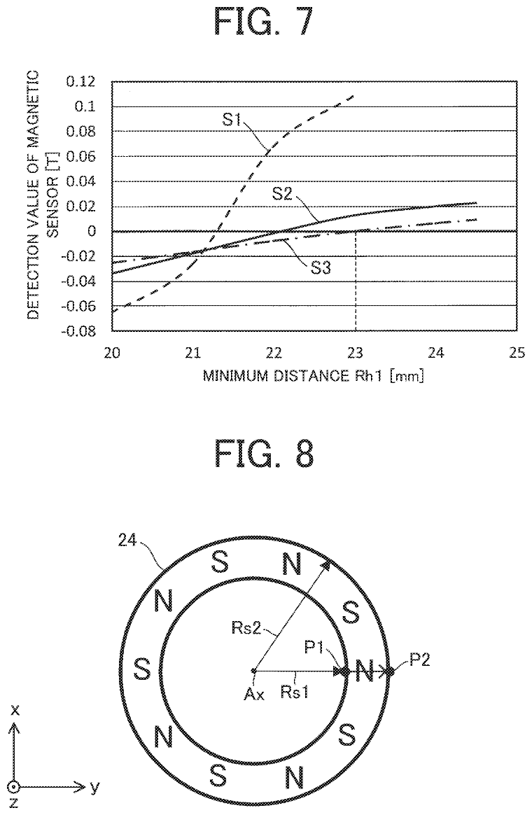

FIG. 7 is a graph showing a relationship between a detection value detected by the magnetic sensor 5 in the electric motor 1 and a position of the magnetic sensor 5. In FIG. 7, the vertical axis represents a detection value [T] of the magnetic sensor 5 in the electric motor 1. Specifically, the vertical axis represents a difference between a maximum value of a magnetic flux density of a north pole component and a maximum value of a magnetic flux density of a south pole component, detected by the magnetic sensor 5 (i.e., the maximum value of the magnetic flux density of the north pole component—the maximum value of the magnetic flux density of the south pole component). The horizontal axis represents the minimum distance Rh1 from the axis line Ax to the magnetic sensor 5.

In FIG. 7, line S1 represents a result detected by the magnetic sensor 5 disposed at a position where the minimum distance L1 from the main magnet 20 to the magnetic sensor 5 in the axial direction is 3 mm, line S2 represents a result detected by the magnetic sensor 5 disposed at a position where the minimum distance L1 is 5 mm, and line S3 is a result detected by the magnetic sensor 5 disposed at a position where the minimum distance L1 is 7 mm.

As shown in FIG. 7, the minimum distance Rh1 where the north pole component and the south pole component flowing into the magnetic sensor 5 coincide with each other (i.e., the minimum distance Rh1 in a case where the detection value is zero) varies in accordance with the minimum distance L1 from the main magnet 20 to the magnetic sensor 5 in the axial direction. In addition, as the minimum distance L1 decreases, the influence of the minimum distance Rh1 from the axis line Ax to the magnetic sensor 5 on a detection result of the magnetic sensor 5 increases. For example, as shown in FIG. 7, in a case where the minimum distance L1 is 3 mm (i.e., line S1 in FIG. 7), the influence of the minimum distance Rh1 from the axis line Ax to the magnetic sensor 5 on the detection result of the magnetic sensor 5 is large.

Thus, the minimum distance L1 from the rotor core 21 to the magnetic sensor 5 in the axial direction is preferably 4 mm or more. Accordingly, the influence of the minimum distance Rh1 from the axis line Ax to the magnetic sensor 5 on the detection result of the magnetic sensor 5 can be reduced. In other words, a variation in the detection result of the magnetic sensor 5 occurring in accordance with a variation of the minimum distance Rh1 can be reduced. For example, even in a case where the placement position of the magnetic sensor 5 is shifted from the predetermined position, the influence of the minimum distance Rh1 can be reduced. As a result, an error in the detection result detected by the magnetic sensor 5 can be reduced and consequently a decrease in motor efficiency can be prevented.

The minimum distance L1 from the rotor core 21 to the magnetic sensor 5 in the axial direction is more preferably 5 mm or more. Accordingly, the influence of the minimum distance Rh1 from the axis line Ax to the magnetic sensor 5 on the detection result of the magnetic sensor 5 can be further reduced. As a result, an error in the detection result detected by the magnetic sensor 5 can be reduced and consequently a decrease in motor efficiency can be prevented.

The minimum distance L1 from the rotor core 21 to the magnetic sensor 5 in the axial direction is much more preferably 7 mm or more. Accordingly, the influence of the minimum distance Rh1 from the axis line Ax to the magnetic sensor 5 on the detection result of the magnetic sensor 5 can be further reduced. As a result, an error in the detection result detected by the magnetic sensor 5 can be reduced and consequently a decrease in motor efficiency can be prevented.

In the case where the minimum distance L1 from the rotor core 21 to the magnetic sensor 5 in the axial direction is 7 mm, the minimum distance Rh1 is preferably 23 mm. Accordingly, magnetic flux well balanced between the north pole component and the south pole component flows into the magnetic sensor 5, and an error in the detection result detected by the magnetic sensor 5 can be reduced and consequently a decrease in motor efficiency can be reduced.

FIG. 8 is a plan view schematically illustrating a structure of the sensor magnet 24. In FIG. 8, “N” represents a north pole of the sensor magnet 24, and “S” represents a south pole of the sensor magnet 24.

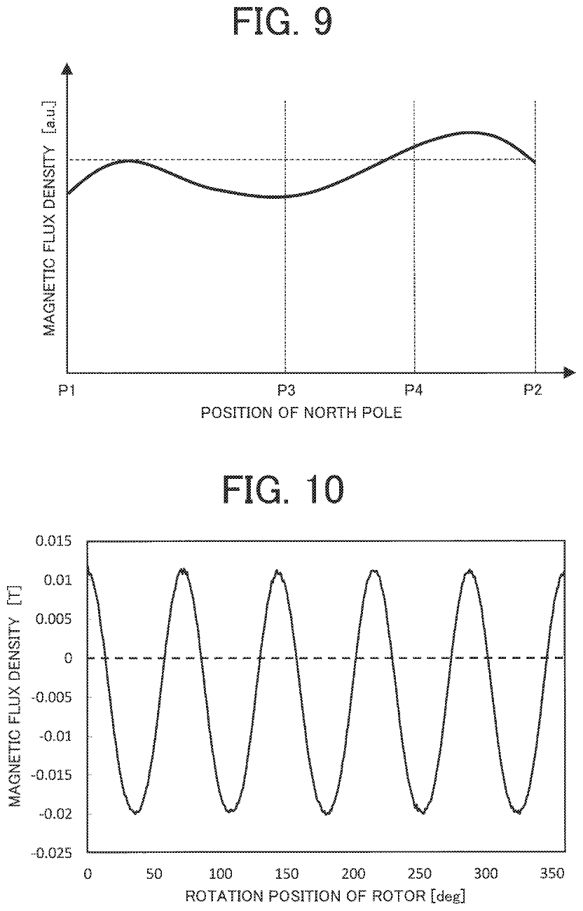

FIG. 9 is a graph showing the magnitude of a magnetic flux density of magnetic flux showing the north pole of the sensor magnet 24 (specifically magnetic flux from the north pole toward the magnetic sensor 5). In FIG. 9, the horizontal axis corresponds to a position from a position P1 to a position P2 in the north pole of the sensor magnet 24 shown in FIG. 8. That is, a distance from the axis line Ax to the position P1 is equal to an inner diameter Rs1 of the sensor magnet 24, and a distance from the axis line Ax to the position P2 is equal to an outer diameter Rs2 of the sensor magnet 24. A distance from the axis line Ax to a position P3 is expressed by (Rs1+Rs2)/2. A distance from the axis line Ax to a position P4 is expressed by (Rs1+Rs2)×3/4.

As shown in FIG. 8, in a case where the sensor magnet 24 is a ring-shaped magnet, the sensor magnet 24 has the inner diameter Rs1 and the outer diameter Rs2. In this case, a relationship among the inner diameter Rs1 of the sensor magnet 24, the outer diameter Rs2 of the sensor magnet 24, and the minimum distance Rh1 satisfies (Rs1+Rs2)/2<Rh1<Rs2. In other words, the magnetic sensor 5 is disposed at a position where (Rs1+Rs2)/2<Rh1<Rs2 is satisfied. Accordingly, magnetic flux flowing from the sensor magnet 24 into the magnetic sensor 5 increases, and the accuracy of the detection result detected by the magnetic sensor 5 can be enhanced. As a result, an error in the detection result detected by the magnetic sensor 5 can be reduced and consequently a decrease in motor efficiency can be prevented.

The relationship among the inner diameter Rs1 of the sensor magnet 24, the outer diameter Rs2 of the sensor magnet 24, and the minimum distance Rh1 more preferably satisfies (Rs1+Rs2)×3/4<Rh1<Rs2. In this case, the magnetic sensor 5 is disposed at a position where the magnetic flux density from the sensor magnet 24 is large. Accordingly, magnetic flux flowing from the sensor magnet 24 into the magnetic sensor 5 further increases, and the accuracy of the detection result detected by the magnetic sensor 5 can be enhanced. As a result, an error in the detection result detected by the magnetic sensor 5 can be reduced and consequently a decrease in motor efficiency can be prevented.

In a case where the magnitude of the magnetic flux density of magnetic flux flowing into the magnetic sensor 5 from the main magnet 20, for example, the amount of leakage flux, differs between the north pole and the south pole of the main magnet 20, an error occurs in the detection result detected by the magnetic sensor 5. For example, in the magnetic sensor 5, in a case where the absolute value of a peak value of a magnetic flux density of magnetic flux showing the north pole of the main magnet 20 is larger than the absolute value of a peak value of a magnetic flux density of magnetic flux showing the south pole of the main magnet 20, an error occurs in the detection result detected by the magnetic sensor 5. Thus, in the magnetic sensor 5, the sensor magnet 24 is magnetized such that the magnetic flux density showing the south pole of the sensor magnet 24 (specifically, the absolute value of the peak value of the magnetic flux density of the south pole component of the sensor magnet 24 detected by the magnetic sensor 5) is larger than the magnetic flux density showing the north pole of the sensor magnet 24 (specifically, the absolute value of the peak value of the magnetic flux density of the north pole component of the sensor magnet 24 detected by the magnetic sensor 5). The magnetic sensor 5 may be disposed such that the absolute value of the peak value of the magnetic flux density showing the south pole of the sensor magnet 24 is larger than the absolute value of the peak value of the magnetic flux density showing the north pole of the sensor magnet 24.

FIG. 10 is a graph showing an example of a change in magnetic flux density of magnetic flux density from the sensor magnet 24 in the electric motor 1.

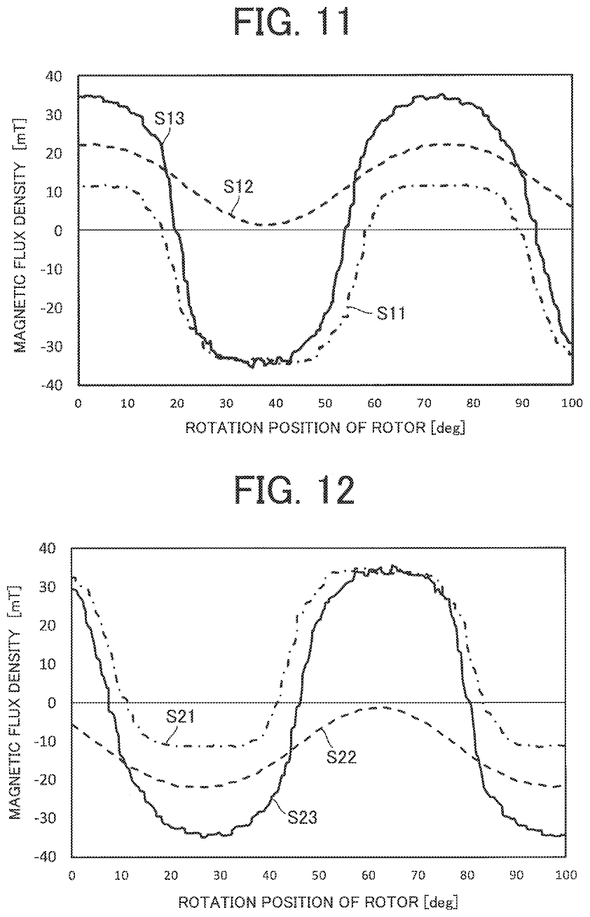

FIG. 11 is a graph showing examples of a change S11 in a magnetic flux density of magnetic flux from the sensor magnet 24, a change S12 in a magnetic flux density of magnetic flux from the main magnet 20, and a change S13 in a magnetic flux density of magnetic flux flowing into the magnetic sensor 5, in the electric motor 1 In FIG. 11, a positive side on the vertical axis represents a magnetic flux density of a north pole component detected by the magnetic sensor 5, and a negative side on the vertical axis represents a magnetic flux density of a south pole component detected by the magnetic sensor 5.

In the example shown in FIG. 10, the absolute value of the peak value of the magnetic flux density of magnetic flux showing the north pole of the sensor magnet 24 is 0.01 [T], and the absolute value of the peak value of the magnetic flux density of magnetic flux showing the south pole of the sensor magnet 24 is 0.02 [T]. Thus, in the magnetic sensor 5, the absolute value of the peak value of the magnetic flux density of magnetic flux showing the south pole of the sensor magnet 24 is larger than the absolute value of the peak value of the magnetic flux density of magnetic flux showing the north pole of the sensor magnet 24. Accordingly, as shown by line S12 in FIG. 11, for example, even in the case of using the main magnet 20 causing unbalanced flux leakage between the north pole component and the south pole component, magnetic flux well balanced between the north pole component and the south pole component flows into the magnetic sensor 5 as shown by line S13. As a result, an error in the detection result detected by the magnetic sensor 5 can be reduced and consequently a decrease in motor efficiency can be prevented.

FIG. 12 is a graph showing examples of a change S21 in a magnetic flux density of magnetic flux from the sensor magnet 24, a change S22 in a magnetic flux density of magnetic flux from the main magnet 20, and a change S23 in a magnetic flux density of magnetic flux flowing into the magnetic sensor 5, in the electric motor 1. In FIG. 12, a positive side on the vertical axis represents a magnetic flux density of a north pole component detected by the magnetic sensor 5, and a negative side on the vertical axis represents a magnetic flux density of a south pole component detected by the magnetic sensor 5.

In the magnetic sensor 5, in a case where the absolute value of a peak value of a magnetic flux density of magnetic flux showing the south pole of the main magnet 20 is larger than the absolute value of a peak value of a magnetic flux density of magnetic flux showing the north pole of the main magnet 20 (e.g., line S22 in FIG. 12), an error occurs in the detection result detected by the magnetic sensor 5. Thus, in the magnetic sensor 5, the peak value of the magnetic flux density of magnetic flux showing the north pole of the sensor magnet 24 is larger than the peak value of the magnetic flux density of magnetic flux showing the south pole of the sensor magnet 24 (e.g., line 21 in FIG. 12). In other words, in the magnetic sensor 5, the sensor magnet 24 is magnetized such that the peak value of the magnetic flux density of magnetic flux showing the north pole of the sensor magnet 24 is larger than the peak value of the magnetic flux density of magnetic flux showing the south pole of the sensor magnet 24. The magnetic sensor 5 may be disposed such that the peak value of the magnetic flux density of magnetic flux showing the north pole of the sensor magnet 24 is larger than the peak value of the magnetic flux density of magnetic flux showing the south pole of the sensor magnet 24.

Accordingly, as shown by line S22 in FIG. 12, for example, even in the case of using the main magnet 20 causing unbalanced flux leakage between the north pole component and the south pole component, magnetic flux well balanced between the north pole component and the south pole component flows into the magnetic sensor 5 as shown by line S23. As a result, an error in the detection result detected by the magnetic sensor can be reduced and consequently a decrease in motor efficiency can be prevented.

Advantages of the electric motor 1 according to the first embodiment will be described below.

As described above, the electric motor 1 according to the first embodiment satisfies Rh1>Rm1. Accordingly, even in a case where the minimum distance L1 from the main magnet 20 to the magnetic sensor 5 in the axial direction varies, an error in the detection result detected by the magnetic sensor 5 can be reduced, and a decrease in motor efficiency can be prevented. As a result, a decrease in motor efficiency can be prevented.

In general, when a current flows in a coil of a stator, a magnetic field is generated from the coil. This magnetic field can affect a detection result of a magnetic sensor in some cases. Thus, the electric motor 1 satisfies R1>Rh1. That is, the electric motor 1 satisfies R1>Rh1>Rm1. Accordingly, influence of a magnetic field generated from the coil 32 on the magnetic sensor 5 is reduced, and an error in a detection result detected by the magnetic sensor 5 can be reduced. As a result, a decrease in motor efficiency can be prevented.

In a case where the minimum distance Rh1 from the axis line Ax to the magnetic sensor 5 is 9 mm or more, an error in the detection result detected by the magnetic sensor 5 can be further reduced. As a result, a decrease in motor efficiency can be prevented.

In addition, in a case where the minimum distance Rh1 from the axis line Ax to the magnetic sensor 5 is 15 mm or more, an error in the detection result detected by the magnetic sensor 5 can be further reduced. As a result, a decrease in motor efficiency can be prevented.

In a case where the minimum distance L1 from the rotor core 21 to the magnetic sensor 5 in the axial direction is 4 mm or more, influence of the minimum distance Rh1 from the axis line Ax to the magnetic sensor 5 on the detection result of the magnetic sensor 5 can be reduced. As a result, an error in the detection result detected by the magnetic sensor 5 can be reduced and consequently a decrease in motor efficiency can be prevented. In a case where the electric motor 1 satisfies L1≥4 mm and Rh1≥9 mm, an error in the detection result detected by the magnetic sensor 5 can be effectively reduced. As a result, a decrease in motor efficiency can be effectively prevented.

In a case where the relationship among the inner diameter Rs1 of the sensor magnet 24, the outer diameter Rs2 of the sensor magnet 24, and the minimum distance Rh1 satisfies (Rs1+Rs2)/2<Rh1<Rs2, the magnetic flux density of magnetic flux flowing from the sensor magnet 24 into the magnetic sensor 5 increases, and the accuracy in detection result detected by the magnetic sensor 5 can be enhanced. As a result, an error in the detection result detected by the magnetic sensor 5 can be reduced and consequently a decrease in motor efficiency can be prevented.

The relationship among the inner diameter Rs1 of the sensor magnet 24, the outer diameter Rs2 of the sensor magnet 24, and the minimum distance Rh1 more preferably satisfies (Rs1+Rs2)×3/4<Rh1<Rs2. Accordingly, the magnetic flux density of magnetic flux flowing from the sensor magnet 24 into the magnetic sensor 5 further increases, and the accuracy in the detection result detected by the magnetic sensor 5 can be enhanced. As a result, an error in the detection result detected by the magnetic sensor 5 can be effectively reduced and consequently a decrease in motor efficiency can be effectively prevented.

In the magnetic sensor 5, in a case where the absolute value of the peak value of the magnetic flux density of magnetic flux showing the south pole of the main magnet 20 is larger than the absolute value of the peak value of the magnetic flux density of magnetic flux showing the north pole of the main magnet 20, the peak value of the magnetic flux density of magnetic flux showing the north pole of the sensor magnet 24 is larger than the peak value of the magnetic flux density of magnetic flux showing the south pole of the sensor magnet 24 in the magnetic sensor 5. Accordingly, even in the case of using the main magnet 20 causing unbalanced flux leakage between the north pole component and the south pole component, magnetic flux well balanced between the north pole component and the south pole component flows into the magnetic sensor 5. As a result, an error in the detection result detected by the magnetic sensor 5 can be reduced and consequently a decrease in motor efficiency can be prevented.

Similarly, in the magnetic sensor 5, in a case where the absolute value of the peak value of the magnetic flux density of magnetic flux showing the north pole of the main magnet 20 is larger than the absolute value of the peak value of the magnetic flux density of magnetic flux showing the south pole of the main magnet 20, the absolute value of the peak value of the magnetic flux density of magnetic flux showing the north pole of the sensor magnet 24 is larger than the absolute value of the peak value of the magnetic flux density of magnetic flux showing the north pole of the sensor magnet 24 in the magnetic sensor 5. Accordingly, even in the case of using the main magnet 20 causing unbalanced flux leakage between the north pole component and the south pole component, magnetic flux well balanced between the north pole component and the south pole component flows into the magnetic sensor 5. As a result, an error in the detection result detected by the magnetic sensor 5 can be reduced and consequently a decrease in motor efficiency can be prevented.

### Second Embodiment

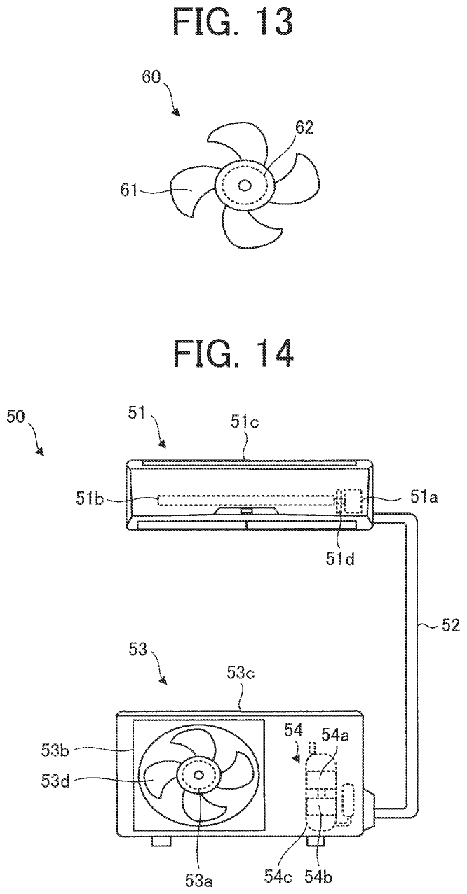

FIG. 13 is a diagram schematically illustrating a configuration of a fan 60 according to a second embodiment of the present invention.

The fan 60 includes a blade 61 and an electric motor 62. The fan 60 is also referred to as an air blower. The electric motor 62 is an electric motor 1 according to the first embodiment. The blade 61 is fixed to a shaft of the electric motor 62. The electric motor 62 drives the blade 61. When the electric motor 62 is driven, the blade 61 rotates, and thus an airflow is generated. In this manner, the fan 60 is capable of sending air.

In the fan 60 according to the second embodiment, the electric motor 1 described in the first embodiment is applied to the electric motor 62, and thus, the same advantages as those described in the first embodiment can be obtained. In addition, a decrease in efficiency of the fan 60 can be prevented.

### Third Embodiment

An air conditioner 50 (also referred to as a refrigeration air conditioning apparatus or a refrigeration cycle apparatus) according to a third embodiment of the present invention will be described.

FIG. 14 is a diagram schematically illustrating a configuration of the air conditioner 50 according to the third embodiment.

The air conditioner 50 according to the third embodiment includes an indoor unit 51 as an air blower (first air blower), a refrigerant pipe 52, and an outdoor unit 53 as an air blower (second air blower) connected to the indoor unit 51 through the refrigerant pipe 52.

The indoor unit 51 includes an electric motor 51a (e.g., the electric motor 1 according to the first embodiment), an air supply section 51b that supplies air when being driven by the electric motor 51a, a housing 51c covering the electric motor 51a and the air supply section 51b. The air supply section 51b includes a blade 51d that is driven by the electric motor 51a, for example. For example, the blade 51d is fixed to a shaft of the electric motor 51a, and generates an airflow.

The outdoor unit 53 includes an electric motor 53a (e.g., the electric motor 1 according to the first embodiment), an air supply section 53b, a compressor 54, and a heat exchanger (not shown). The air supply section 53b supplies air when being driven by the electric motor 53a. The air supply section 53b includes a blade 53d that is driven by the electric motor 53a, for example. For example, the blade 53d is fixed to a shaft of the electric motor 53a, and generates an airflow. The compressor 54 includes an electric motor 54a (e.g., the electric motor 1 according to the first embodiment), a compression mechanism 54b (e.g., a refrigerant circuit) that is driven by the electric motor 54a, and a housing 54c covering the electric motor 54a and the compression mechanism 54b.

In the air conditioner 50, at least one of the indoor unit 51 or the outdoor unit 53 includes the electric motor 1 described in the first embodiment. Specifically, the electric motor 1 described in the first embodiment is applied, as a driving source of the air supply section, to at least one of the electric motors 51a or 53a. In addition, the electric motor 1 described in the first embodiment may be applied to the electric motor 54a of the compressor 54.

The air conditioner 50 is capable of performing air conditioning such as a cooling operation of sending cold air and a heating operation of sending warm air from the indoor unit 51, for example. In the indoor unit 51, the electric motor 51a is a driving source for driving the air supply section 51b. The air supply section 51b is capable of sending conditioned air.

In the air conditioner 50 according to the third embodiment, the electric motor 1 described in the first embodiment is applied to at least one of the electric motors 51a or 53a, the same advantages as those described in the first embodiment can be obtained. In addition, a decrease in efficiency of the air conditioner 50 can be prevented.

Furthermore, the use of the electric motor 1 according to the first embodiment as a driving source of the air blower (e.g., the indoor unit 51) can obtain the same advantages as those described in the first embodiment. Accordingly, a decrease in efficiency of the air blower can be prevented. The air blower including the electric motor 1 according to the first embodiment and the blade (e.g., the blade 51d or 53d) that is driven by the electric motor 1 can be used alone as an air sending device. This air blower is also applicable to equipment other than the air conditioner 50.

In addition, the use of the electric motor 1 according to the first embodiment as a driving source of the compressor 54 can obtain the same advantages as those described in the first embodiment. Further, a decrease in efficiency of the compressor 54 can be prevented.

The electric motor 1 described in the first embodiment can be mounted on equipment including a driving source, such as a ventilator, a household electrical appliance, or a machine tool, other than the air conditioner 50.

Features of the embodiments and features of the variations in the embodiments described above may be combined as appropriate.

1. An electric motor comprising:
a consequent-pole type rotor having a rotation axis and including a rotor core, a permanent magnet fixed to the rotor core, and a sensor magnet fixed to the rotor core;
a stator disposed outside the consequent-pole type rotor; and
a magnetic sensor to detect magnetic flux from the sensor magnet, wherein
the electric motor satisfies Rh1>Rm1
where Rh1 is a minimum distance from the rotation axis to the magnetic sensor, and Rm1 is a minimum distance from the rotation axis to the permanent magnet.

2. The electric motor according to claim 1, wherein the electric motor satisfies R1>Rh1
where R1 is a maximum radius of the rotor core.

3. The electric motor according to claim 1, wherein the electric motor satisfies 9 mm≤Rh1≤23 mm.

4. The electric motor according to claim 1, wherein the electric motor satisfies 15 mm≤Rh1≤23 mm.

5. The electric motor according to claim 1, wherein a minimum distance from the rotor core to the magnetic sensor in an axial direction is 4 mm or more and 7 mm or less.

6. The electric motor according to claim 1, wherein
the sensor magnet is a ring-shaped magnet, and
the electric motor satisfies
(Rs1+Rs2)/2<Rh1<Rs2
where Rs1 is an inner diameter of the sensor magnet, and Rs2 is an outer diameter of the sensor magnet.

7. The electric motor according to claim 1, wherein
the sensor magnet is a ring-shaped magnet, and
the electric motor satisfies
(Rs1+Rs2)×3/4<Rh1<Rs2
where Rs1 is an inner diameter of the sensor magnet, and Rs2 is an outer diameter of the sensor magnet.

8. The electric motor according to claim 1, wherein
the consequent-pole type rotor further includes a main magnet including the rotor core and the permanent magnet, and
in a case where an absolute value of a peak value of a magnetic flux density of magnetic flux showing a south pole of the main magnet is larger than an absolute value of a peak value of a magnetic flux density of magnetic flux showing a north pole of the main magnet in the magnetic sensor, an absolute value of a peak value of a magnetic flux density of magnetic flux showing a north pole of the sensor magnet is larger than an absolute value of a peak value of a magnetic flux density of magnetic flux showing a south pole of the sensor magnet in the magnetic sensor.

9. The electric motor according to claim 1, wherein
the consequent-pole type rotor further includes a main magnet including the rotor core and the permanent magnet, and
in a case where an absolute value of a peak value of a magnetic flux density of magnetic flux showing a north pole of the main magnet is larger than an absolute value of a peak value of a magnetic flux density of magnetic flux showing a south pole of the main magnet in the magnetic sensor, an absolute value of a peak value of a magnetic flux density of magnetic flux showing a south pole of the sensor magnet is larger than an absolute value of a peak value of a magnetic flux density of magnetic flux showing a north pole of the sensor magnet in the magnetic sensor.

10. A fan comprising:
a blade; and
an electric motor to drive the blade, wherein
the electric motor includes
a consequent-pole type rotor having a rotation axis and including a rotor core, a permanent magnet fixed to the rotor core, and a sensor magnet fixed to the rotor core,
a stator disposed outside the consequent-pole type rotor, and
a magnetic sensor to detect magnetic flux from the sensor magnet, and
the electric motor satisfies Rh1>Rm1
where Rh1 is a minimum distance from the rotation axis to the magnetic sensor, and Rm1 is a minimum distance from the rotation axis to the permanent magnet.

11. An air conditioner comprising:
an indoor unit; and
an outdoor unit connected to the indoor unit, wherein
at least one of the indoor unit or the outdoor unit includes an electric motor,
the electric motor includes
a consequent-pole type rotor having a rotation axis and including a rotor core, a permanent magnet fixed to the rotor core, and a sensor magnet fixed to the rotor core,
a stator disposed outside the consequent-pole type rotor, and
a magnetic sensor to detect magnetic flux from the sensor magnet, and
the electric motor satisfies Rh1>Rm1
where Rh1 is a minimum distance from the rotation axis to the magnetic sensor, and Rm1 is a minimum distance from the rotation axis to the permanent magnet.

12. The electric motor according to claim 1, wherein part of the sensor magnet overlaps with the permanent magnet in a plane orthogonal to the rotation axis.
